(19) United States
(12) Patent Application Publication
(10) Pub. No.: US 2019/0084811 A1
(43) Pub. Date: Mar. 21, 2019

(54) COUPLING UNIT FOR LATTICE STRUCTURE CONSTITUTING WORK MACHINE

(71) Applicant: Kobelco Construction Machinery Co., Ltd., Hiroshima-shi (JP)

(72) Inventors: Hiromitsu HAMAGUCHI, Hyogo (JP); Toshiharu Yamashita, Hyogo (JP); Yoshihide Nishikawa, Hyogo (JP); Takunori Yamaguchi, Hyogo (JP); Teppei Maedo, Hyogo (JP)

(73) Assignee: Kobelco Construction Machinery Co., Ltd., Hiroshima-hi (JP)

(21) Appl. No.: 16/103,953

(22) Filed: Aug. 15, 2018

(30) Foreign Application Priority Data
Aug. 18, 2017 (JP) 2017-157851

(51) Int. Cl. B66C 23/70

(52) U.S. Cl. CPC B66C 23/70

(57) ABSTRACT

Provided is a coupling unit capable of accurately determining a relative position between connectors despite welding across main pipes and connectors in a lattice structure. A coupling unit includes connectors to be joined to ends of main pipes, and a connector interconnection member that interconnects connectors to one another. Each of the connectors includes: a fitted part fittable to the end of the main pipe; a detachable connection part detachably connectable to a counterpart connector provided to an end of the other lattice structure; an outer peripheral surface weldable to an outer peripheral surface of the end of the main pipe while the fitted part is fitted to the end of the main pipe; and a connected part to which an end of the connector interconnection member is to be connected.

### TECHNICAL FIELD

The present invention relates to a lattice structure constituting a work machine.

### BACKGROUND ART

There is generally employed, for a raisable and lowerable member for working provided to a large work machine such as a large crane, a lattice structure which is lightweight and has high rigidity. Furthermore, in order to transport a long raisable-lowerable member, it is constituted by a plurality of lattice structures detachably coupled to one another. In such a case, each lattice structure is provided with a plurality of connectors for connecting the lattice structure to an adjacent lattice structure.

Japanese Unexamined Patent Publication No. 2009-149438 (Patent Literature 1) discloses a plurality of boom segments constituting a boom of a crane. Each of the boom segments includes four main pipes (“top chord” and “bottom chord” in Patent Literature 1) and multiple connection pipes (“lattice elements” in Patent Literature 1) that connect the main pipes to one another to form a lattice structure. The plurality of boom segments includes a first boom segment and a second boom segment which are connected to each other. A first connector is joined to an end of each of the main pipes constituting the first boom segment, and a second connector is joined to an end of each of the main pipes constituting the second boom segment, the second connector being configured to be detachably connected to the corresponding first connector. The first and second connectors are provided with respective pin holes, into which a common connecting pin is inserted to interconnect the first and second connectors to thereby interconnect the first boom segment and the second boom segment.

Generally, for joining the first and second connectors to respective ends of the main pipes, welding is performed. Japanese Unexamined Patent Publication No. 2003-117693 (Patent Literature 2) discloses a method for welding a main pipe and a yoke constituting a connector. The yoke has a fitted part capable of being fitted into an end of the main pipe, and the boundary between the yoke and the main pipe which are fitted with each other is welded over the entire circumference.

The welding for joining the main pipes and the first and second connectors, however, generates thermal strain in joint portions therebetween. The thermal strain causes a change in a relative positions between the plurality of first connectors and that of the plurality of second connectors which are welded to the plurality of main pipes, respectively, particularly a change in the relative positions in a direction perpendicular to an axial direction of the main pipes. In the worst case, the thermal strain may disable the plurality of first connectors and the plurality of corresponding second connectors from being interconnected. It may allow the first connector and the second connector to be interconnected to perform welding and thereafter to form a pin hole in each of the connectors, regardless of the thermal strain, but thus forming the pin holes later entails significant reduction in production efficiency.

Although above-mentioned Patent Literature 2 also discloses a method for welding the main pipe and yokes serving as connectors in a state where the yokes are axially pressed against opposite ends of the main pipe to fix the relative position therebetween, this method requires a large special pressing cylinder and, further requires continuously applying axial force to each of the yokes through the pressing cylinder for a long time. In addition, when the axial force is released after the completion of the welding, residual strain can cause relative displacement between the yokes.

### SUMMARY OF INVENTION

An object of the present invention is to provide a technique making it possible to accurately define relative positions of a plurality of connectors regardless of welding across a plurality of main pipes and the plurality of connectors in a lattice structure constituting a work machine.

To achieve the foregoing object, the present inventors have focused on a plurality of connection members included in the lattice structure constituting the work machine. The plurality of connection members are used for interconnecting the plurality of main pipes constituting the lattice structure. Using connector interconnection members in place of or in addition to a part of the plurality of connection members and joining the connector interconnection members not to the plurality of main pipes but to a plurality of connectors to be welded to respective ends of the plurality of main pipes to interconnect the plurality of connectors enables the relative positions of the plurality of connectors to each other to be accurately determined without requiring large equipment.

The present invention is accomplished in view of the above circumstance, providing a coupling unit to form an end of a lattice structure and to be coupled to an end of another lattice structure adjacent to the lattice structure, the lattice structure including a plurality of main pipes and a plurality of connection members that connects the plurality of main pipes to one another in a state where the plurality of main pipes are spaced perpendicularly to their respective axial directions of the main pipes. The coupling unit includes: a plurality of connectors disposed at respective axial ends of the plurality of main pipes and joined to the axial ends; and at least one connector interconnection member that interconnects the plurality of connectors. Each of the plurality of connectors includes: a fitted part capable of being fitted to an end of the main pipe corresponding to the connector; a detachable connection part that is detachably connectable to a counterpart connector provided to an end of the other lattice structure; an outer peripheral surface that is weldable to an outer peripheral surface of the end of the main pipe over an entire circumference of the main pipe in a state where the fitted part is fitted to the end of the main pipe; and a connected part to which an end of the connector interconnection member is to be connected.

### BRIEF DESCRIPTION OF DRAWINGS

FIG. 1 is a side view of a crane according to an embodiment of the present invention;

FIG. 2 is an enlarged view of a portion enclosed by a rectangle II in FIG. 1;

FIG. 3 is a perspective view of a second boom member constituting a lattice boom of the crane;

FIG. 4 is a partially sectioned plan view of a structure for interconnecting the second boom member and a third boom member which is another lattice structure adjacent to the second boom member;

FIG. 5 is a perspective view of a connector constituting the second boom member and respective ends of a main pipe and connector interconnection members which are to be welded to the connector; and

FIG. 6 is a partially sectioned plan view of a interconnection structure of a second boom member and a third boom member according to a comparative example.

### DESCRIPTION OF EMBODIMENT

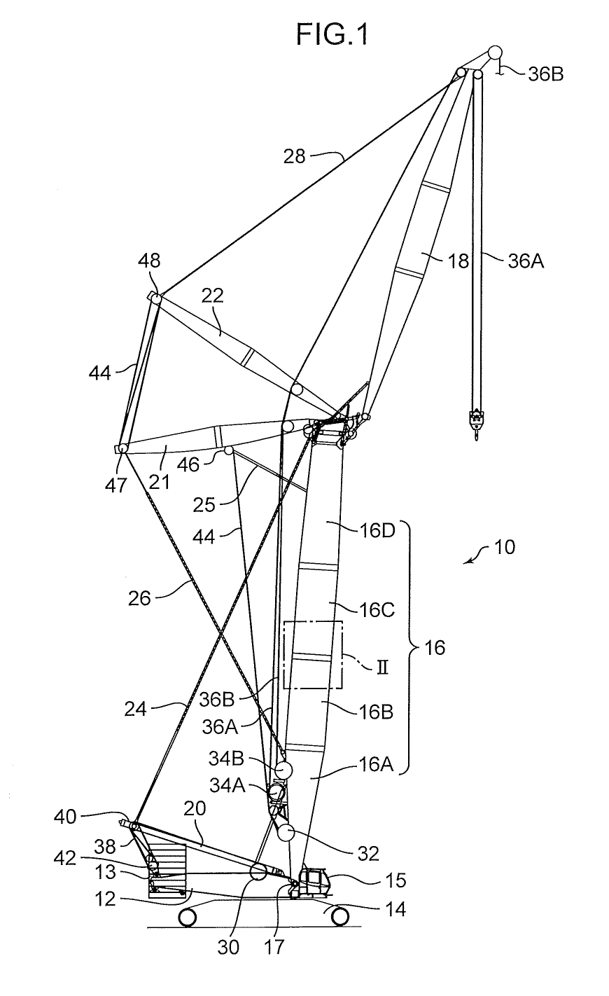

There will be described below an embodiment of the present invention with reference to the drawings. FIG. 1 is a side view of a crane 10 according to an embodiment of the present invention. In the following, “upper”, “lower”, “front”, and “rear” directions are indicated in each of the drawings, but such directions are conveniently used for describing the structure and assembling method of the crane 10 according to the present invention and do not intend to limit a direction of movement and a mode of use of the crane 10.

The crane 10 includes an upper slewing body 12, a lower travelling body 14 that supports the upper slewing body 12 so as to allow the upper slewing body 12 to slew, a lattice boom 16, a jib 18, a mast 20, a rear strut 21, and a front strut 22. On the rear part of the upper slewing body 12, a counterweight 13 is loaded for adjusting balance of the crane 10. On the front part of the upper slewing body 12, a cab 15 is mounted including a driver seat.

The lattice boom 16 has a lower end forming a boom foot 17, supported to a slewing frame of the upper slewing body 12 so as to be rotatable in a raising and lowering direction about the lower end. The lattice boom 16 includes a plurality of lattice structures connected to one another, namely, a first boom member 16A, a second boom member 16B, a third boom member 16C, and a fourth boom member 16D arranged in this order from a proximal end thereof.

The first boom member 16A, which is a proximal-end side boom member, has a proximal end including the boom foot 17 and a distal end opposite to the proximal end. The boom foot 17 is connected to the front part of the upper slewing body 12 so as to be rotatable in the raising and lowering direction.

The second to fourth boom members 16B, 16C, and 16D are arranged in this order from the side closer to the first boom member 16A, and each pair of the boom members adjacent to each other in the arranging direction (that is, the axial direction of the lattice boom 16) are detachably coupled to each other. Specifically, the second and third boom members 16B and 16C are intermediate boom members, each having a proximal end detachably coupled to the adjacent boom member on the proximal end side and a distal end detachably coupled to the adjacent boom member on the distal end side. Fourth boom member 16D is a distal-side boom member, having a proximal end detachably coupled to the distal end of the third boom member 16C and a distal end which is opposite to the proximal end and serves a distal end of the entire lattice boom 16.

The jib 18 is connected rotatably to the distal end of the lattice boom 16, that is, the distal end of the fourth boom member 16D. The mast 20, the rear strut 21, and the front strut 22 are members for rotating the jib 18. The rear strut 21 and the front strut 22 are pivotally supported at the distal end of the lattice boom 16 to be rotatable. The mast 20 has a proximal end supported by the upper slewing body 12 so as to be rotatable in a direction same as the raising/lowering direction of the boom 16 and a distal end opposite to the proximal end. The distal end of the mast 20 is connected to the distal end of the boom 16 via a pair of right and left guy lines 24. The rear strut 21 is held by a pair of right and left back stops 25 and guy links 26 in such an attitude that the rear strut 21 extends from the distal end of the lattice boom 16 toward the boom upright side (to the left in FIG. 1). The front strut 22 is connected to the jib 18 through a pair of right and left jib guide lines 28 so as to rotate in conjunction with the jib 18 (so as to rotate integrally with the jib 18).

On the upper slewing body 12, a plurality of winches are mounted. The plurality of winches includes a boom raising-lowering winch 30, a jib raising-lowering winch 32, a main winch 34A, and an auxiliary winch 34B. The boom raising-lowering winch 30 winds up and feeds out a boom raising-lowering rope 38 to rotate the mast 20, thereby raising and lowering the lattice boom 16. The boom raising-lowering rope 38 is wound between sheave blocks 40 and 42 which are provided at the rotating end of the mast 20 and the rear end of the upper slewing body 12, respectively. The jib raising-lowering winch 32 winds up and feeds out a jib raising-lowering rope 44 wound between the rear strut 21 and the front strut 22 to rotate the front strut 22, thereby raising and lowering the jib 18. The jib raising-lowering rope 44 is laid over a guide sheave 46 provided in the longitudinal middle of the rear strut 21 and wounded between sheave blocks 47 and 48 which are provided at the rotating end of the rear strut 21 and the rotating end of the front strut 22, respectively.

The main winch 34A hoists and lowers a suspended load suspended from the distal end of the jib 18 through a main rope 36A, and the auxiliary winch 34B hoists and lowers the suspended load suspended from the distal end of the jib 18 through an auxiliary rope 36B.

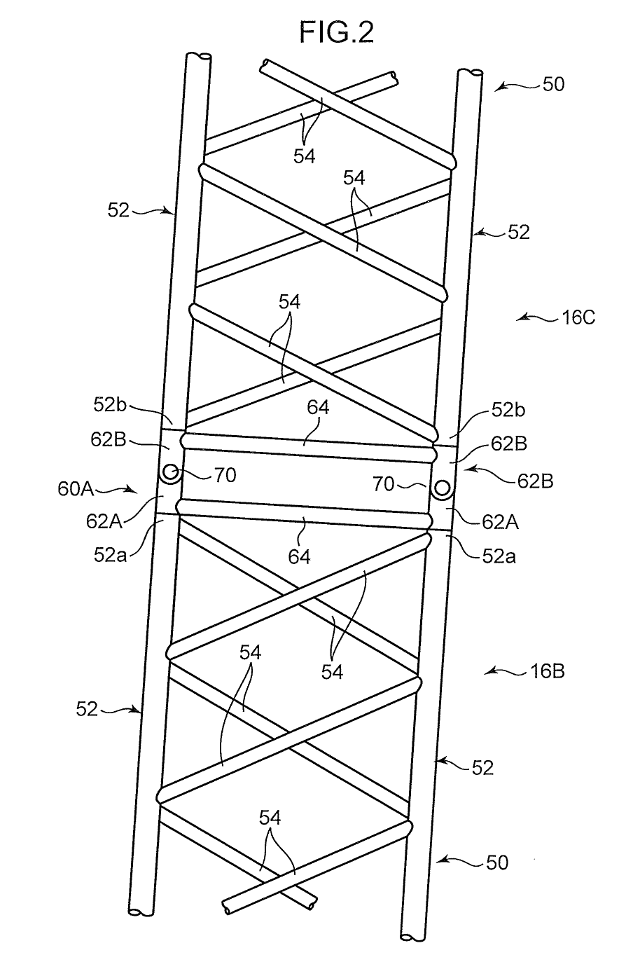

In the above-described crane 10, each of the first to fourth boom members 16A to 16D constituting the lattice boom 16 has a common basic structure. Hence, described below is, for example, the basic structure of the second boom member 16B and the basic structure of the third boom member 16C adjacent to the second boom member 16B among the first to fourth boom members 16A to 16D, and a structure for detachably coupling the second boom member 16B and the third boom member 16C to each other as shown in FIG. 2, with reference to FIGS. 2 to 5.

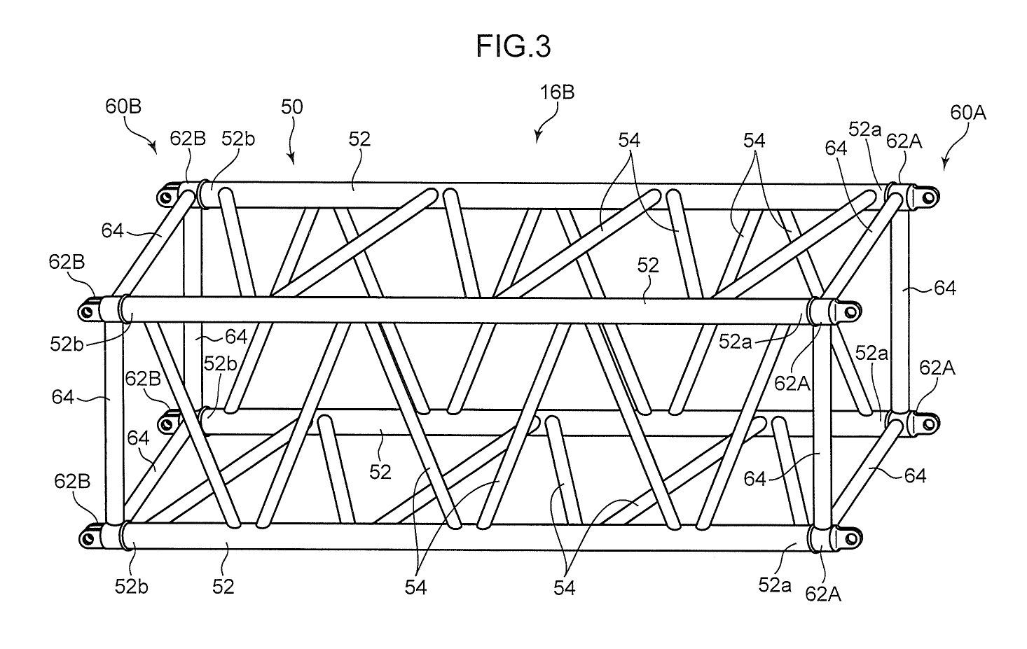

As shown in FIG. 3, the second boom member 16B includes a structure body 50, a first coupling unit 60A, and a second coupling unit 60B. Similarly, the third boom member 16C also includes a structure body 50, a first coupling unit 60A, and a second coupling unit 60B. The first and second coupling units 60A and 60B are designed to detachably couple the lattice structure including the first and second coupling units 60A and 60B to another adjacent lattice structure. For example, as shown in FIG. 2, the first coupling unit 60A of the second boom member 16B constitutes a distal end of the second boom member 16B, while the second coupling unit 60B of the third boom member 16C constitutes a proximal end of the third boom member 16C. The first and second coupling units 60A and 60B are connected to each other, whereby the second boom member 16B and the third boom member 16C are coupled to each other.

The concept of the “lattice structure” and the concept of “another lattice structure” in the present invention are relative ones. For example, when the second boom member 16B is regarded as the “lattice structure” in the present invention, the first coupling unit 60A of the second boom member 16B corresponds to the “coupling unit” in the present invention, and the third boom member 16C corresponds to “another lattice structure” adjacent to the “lattice structure”. On the contrary, when the third boom member 16C is regarded as the “lattice structure” in the present invention, the second coupling unit 60B of the third boom member 16C corresponds to the “coupling unit” in the present invention, and the second boom member 16B corresponds to “another lattice structure”.

The structure body 50 has a longitudinal direction corresponding to the axial direction of the boom 16. The structure body 50 includes a plurality of main pipes 52 and a plurality of connection members 54. The plurality of connection members 54 connect the plurality of main pipes 52 to one another in a state where the plurality of main pipes 52 are spaced perpendicularly to the axial direction of the main pipes 52. The plurality of main pipes 52 and the plurality of connection members 54 are joined to one another to form the lattice structure.

Each of the plurality of main pipes 52 is formed of a linear pipe member having a first end 52a and a second end 52b opposite to the first end 52a. The plurality of main pipes 52 are disposed in parallel to each other so as to extend in a direction, which is parallel to the axial direction of the lattice boom 16 and corresponds to the longitudinal direction of the structure body 50. Specifically, the plurality of main pipes 52 are disposed at respective positions corresponding to vertices of a polygon having three or more vertices when viewed in the axial direction of the main pipes 52. Since each of the intermediate boom members 16B and 16C, the lattice structures in the present embodiment, has four main pipes 52, the main pipes 52 are disposed at respective positions corresponding to four vertices of a rectangle (substantially square in the example in FIG. 3).

Each of the first ends 52a is directed to the distal end side (the side closer to the distal end of the lattice boom 16) of the second and third boom members 16B and 16C, while each of the second ends 52b is directed to the proximal end side (the side closer to the boom foot 17 of the lattice boom 16) opposite to the distal end side.

The plurality of connection members 54 are arranged to connect each of the main pipes 52 to the other main pipe 52 adjacent to the former main pipe 52. Each of the plurality of connection members 54 is formed of a linearly extending structure member (a pipe member in the present embodiment). One of opposite ends of each of the connection members 54 is joined to one of the plurality of main pipes 52, and the other end is joined to the main pipe 52 adjacent to the main pipe 52 to which the one end is joined. Each of the connection members 54 corresponds to a so-called diagonal member, being disposed in an attitude inclined to the axial direction of the main pipe 52 to form a lattice structure advantageous for strength. Each of the connection members 54, alternatively, may be disposed in a direction perpendicular to the axial direction of the main pipes 52.

The first coupling unit 60A includes a plurality of first connectors 62A and a plurality of connector interconnection members 64, and is connected to the first ends 52a of the plurality of main pipes 52 of the structure body 50, thereby forming one end of the lattice structure (for example, the second boom member 16B). Similarly, the second coupling unit 60B includes a plurality of second connectors 62B and a plurality of connector interconnection members 64, and is connected to the second ends 52b of the plurality of main pipes 52 of the structure body 50, thereby forming the other end of the lattice structure. Each of the plurality of connector interconnection members 64 is formed of a structure member extending in one direction (a pipe member in the present embodiment similarly to the connection member 54).

The plurality of first connectors 62A are disposed at the first ends 52a of the plurality of main pipes 52, respectively, and joined to the first ends 52a by welding. Similarly, the plurality of second connectors 62B are disposed at the second ends 52b of the plurality of main pipes 52, respectively, and joined to the second ends 52b by welding. The plurality of first connectors 62A are detachably connected to the second connectors 62B of the second coupling unit 60B, respectively, which is included in another lattice structure (third boom member 16C in the example described below) immediately adjacent to the lattice structure (second boom member 16B in this example) including the first connectors 62A at the distal end side thereof.

Thus, the concept of the “connector” and the concept of the “counterpart connector” in the present invention are also relative ones. For example, when the first connector 62A of the second boom member 16B described below is regarded as the “connector” in the present invention, the second connector 62B of the third boom member 16C corresponds to the “counterpart connector” in the present invention. On the contrary, when the second connector 62B of the third boom member 16C is regarded as the “connector” in the present invention, the first connector 62A of the second boom member 16B corresponds to the “counterpart connector” in the present invention.

Each of the plurality of first connectors 62A includes a connector body 66, a fitted part 67, and a first projecting piece 68A. Similarly, each of the plurality of second connectors 62B includes a connector body 66 and a fitted part 67 which are equivalent to the connector body 66 and the fitted part 67 described above, respectively, and a pair of second projecting pieces 68B capable of being detachably connected to the first projecting piece 68A.

The connector body 66 is located between the fitted part 67 and the first projecting piece 68A (second projecting pieces 68B in the second connector 62B). The connector body 66 includes a connected part to which an end of one of the plurality of connector interconnection members 64 can be connected. In the present embodiment, the connector body 66 has an axial dimension large enough to allow the end of the connector interconnection member 64 to be joined to the connector body 66 over the entire circumference of the connector interconnection member 64. In other words, the connected part included in the connector body 66 has a size allowing the end of the connector interconnection member 64 to be joined to the connected part over the entire circumference of the connector interconnection member 64.

The connector body 66 in the present embodiment has a cylindrical shape with an outer diameter substantially equal to the outer diameter of each main pipe 52. The connector body 66 in the first connector 62A, therefore, has a cylindrical outer peripheral surface 66a capable of being welded to an outer peripheral surface of the first end 52a of each main pipe 52 (the outer peripheral surface of the second end 52b, in the case of the connector body 66 of the second connector 62B) over the entire circumference.

The fitted part 67 has a shape capable of being fitted with the end of each of the plurality of main pipes 52 (the first end 52a of the first connector 62A, and the second end 52b of the second connector 62B). Specifically, the fitted part 67 projects in the axial direction of the connector body 66 beyond the end closer to the main pipe 52 out of the opposite ends of the connector body 66 in the axial direction, having a shape capable of being fitted into the first end 52a (or second end 52b) with a slight clearance. The fitted part 67 in the present embodiment has a cylindrical shape having an outer diameter slightly smaller than the inner diameter of the main pipe 52. However, the fitted part 67 is not limited thereto. For example, the fitted part 67 can be formed of a plurality of projecting parts arranged along the inner peripheral surface of the main pipe 52.

The first projecting piece 68A is inserted between a pair of second projecting pieces 68B of the second connector 62B and detachably connected to the pair of second projecting pieces 68B by use of a connecting pin 70. Thus, the first projecting piece 68A constitutes a male-type detachable connection part to be detachably connected to the pair of second projecting pieces 68B of the second connector 62B which is a counterpart connector, and the pair of second projecting pieces 68B constitute a female-type detachable connection part.

In the present embodiment, the first projecting piece 68A has a substantially flat plate shape and projects one end of the opposite ends of the connector body 66 of the first connector 62A, the one end being the end opposite to the fitted part 67, by a predetermined dimension. Similarly, each of the pair of second projecting pieces 68B has a substantially flat shape, and projects from one end of the opposite ends of the connector body 66 of the second connector 62B, the one end being the end opposite to the fitted part 67, by a predetermined dimension. The pair of second projecting pieces 68B leave a space therebetween that allows the first projecting piece 68A to be inserted to the space.

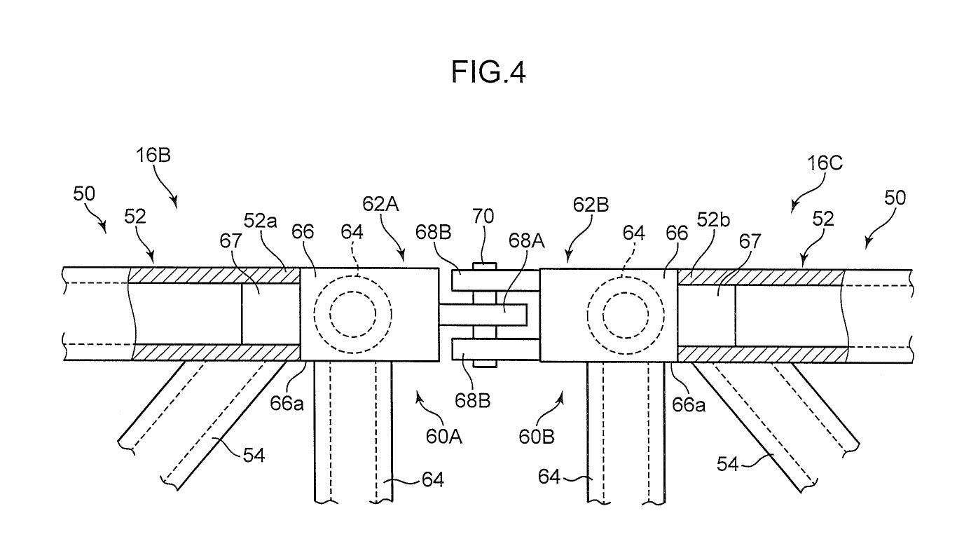

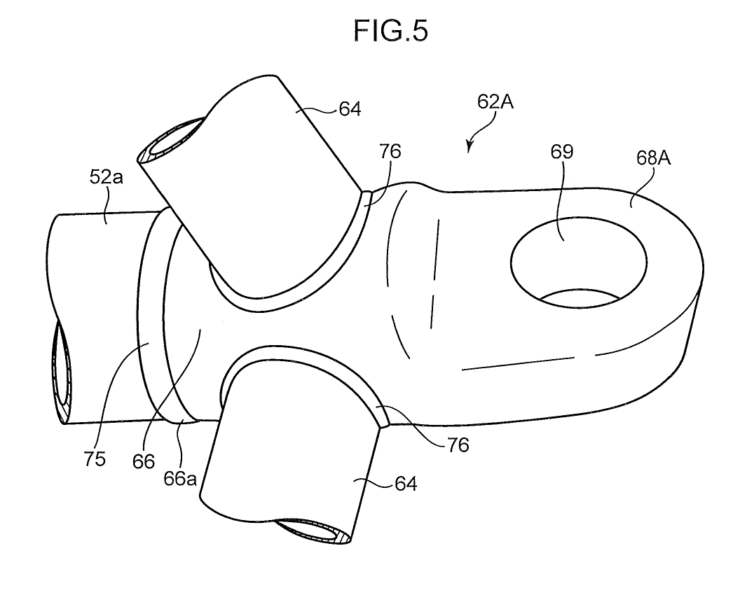

Each of the first and second projecting pieces 68A and 68B is formed with a pin insertion hole 69 as shown in FIG. 5. Each pin insertion hole 69 has an inner diameter that allows the connecting pin 70 to be inserted therethrough. The pin insertion holes are formed at respective positions where, as shown in FIG. 4, the first projecting piece 68A and the second projecting pieces 68B can be detachably connected to each other such that the connecting pin 70 passes through the pin insertion holes to penetrate the first and second projecting pieces 68A and 68B in a thickness direction (direction perpendicular to the axial direction of the connector body 66) of the first and second projecting pieces 68A and 68B in a state where the first projecting piece 68A and the second projecting pieces 68B overlap each other in the thickness direction.

The plurality of first connectors 62A, which are joined to the first ends 52a of the main pipes 52, respectively, are disposed at respective positions corresponding to vertices of the polygon (rectangle in the present embodiment) having three or more vertices. On the other hand, each of the plurality of connector interconnection members 64 is disposed so as to interconnect one of the plurality of the first connectors 62A and the adjacent first connector 62A. Specifically, each of the first coupling unit 60A and the second coupling unit 60B according to the present embodiment includes four connector interconnection members 64; the four connector interconnection members 64 are disposed at respective positions corresponding to sides of the polygon (rectangle in the present embodiment); one of the opposite ends of each of the connector interconnection members 64 is joined to the outer peripheral surface of the connector body 66 of one of the first connectors 62A (one of the second connectors 62B in the second coupling unit 60B); and the other end is joined to the outer peripheral surface of the connector body 66 of another first connector 62A (second connector 62B) adjacent to the above one of the first connectors 62A (second connectors 62B).

The second and third boom members 16B and 16C can be manufactured according to a method including, for example, the following steps.

1) Step of Preparing Structure Body 50

This step includes, for example, preparing the plurality of main pipes 52 and the plurality of connection members 54, and joining the end of each of the connection members 54 to appropriate outer peripheral surfaces of the main pipes 52 by welding to thereby interconnect the plurality of main pipes 52 through the plurality of connection members 54. The “step of preparing the structure body” is, however, not limited thereto. This step only has to be a step enabling the structure body with a lattice structure including the plurality of main pipes and the plurality of connection members to be obtained as a final product.

2) Step of Preparing the Plurality of First Connectors 62A, the Plurality of Second Connectors 62B, and the Plurality of Connector Interconnection Members 64

This step also only has to be a process enabling the plurality of first connectors 62A, the plurality of second connectors 62B, and the plurality of connector interconnection members 64 to be finally obtained; therefore, specific measures for obtaining them are not limited. For example, the entire first connector 62A and/or the entire second connectors 62B can be provided as a single cast by casting, or formed by machining such as cutting out. Alternatively, it is also possible to join the first projecting piece 68A and the second projecting pieces 68B to the connector bodies 66 by welding. Besides, this step may be performed before the “step of preparing the structure body”.

3) Coupling Unit Connecting Step

This step includes connecting the first coupling unit 60A and the second coupling unit 60B to the opposite ends of the structure body 50, respectively, to form the second boom member 16B. In this step, the method for connecting the second coupling unit 60B to the second ends 52b of the plurality of main pipes 52, that is, one end of the structure body 50, is equivalent to the method for connecting the first coupling unit 60A to the first ends 52a of the plurality of main pipes 52, that is, the other end of the structure body 50; hence, only the latter method will be described below as a representative example of these methods. The method includes the following steps.

3-1) Connector Temporary Joining Step

In this step, the first connectors 62A are temporarily joined to the first ends 52a of the plurality of main pipes 52, respectively. The temporary joining step includes at least fitting the fitted parts 67 of the first connectors 62A into the first ends 52a, respectively. By these fittings, the relative positions of the first end 52a and the first connector 62A are roughly determined.

More preferably, the temporary joining includes not only the fittings described above but also joining the first end 52a and the first connector 62A to each other in a degree lower than the degree in which a full joining is performed, specifically, in such a degree as to prevent the first connector 62A from being disengaged from the first end 52a while allowing the first connector 62A to be displaced relatively to the first end 52a within a slight range, particularly in a direction perpendicular to the axial direction of the main pipe 52. The above full joining is to join the main pipe 52 and the first connector 62A to each other by welding across the outer peripheral surface of the first end 52a and the outer peripheral surface 66a of the connector body 66 over the entire circumference while the fitted part 67 is fitted into the first end 52a. In contrast, preferable examples of the temporary joining in addition to the fitting include: spot welding performed at a plurality of circumferentially spaced positions in the outer peripheral surface; simple riveting; and temporary fastening through a bolt.

3-2) Connection Unit Forming Step

This step includes interconnecting the plurality of first connectors 62A through the plurality of connector interconnection members (four connector interconnection members in the present embodiment) 64 in the state where the plurality (four in the present embodiment) of first connectors 62A are fitted to the first ends 52a, respectively (more preferably, in the state where the connector interconnection members 64 are brought into the temporary joining with the first ends 52a, respectively). The first coupling unit 60A is thereby formed. Specifically, to the connected part included in the connector body 66 of each of the first connectors 62A, one end of the connector interconnection member 64 corresponding to the connected part is joined.

The joining only has to be done in a degree enough to fix relative positions of the plurality of first connectors 62A to each other through the connector interconnection members 64, not being required to be a full joining, that is, a joining achieved by welding the end of the connector interconnection member 64 to the outer peripheral surface of the connector body 66 over the entire circumference of the connector interconnection member 64. For example, it is permissible that, in this step, that is, in the step of forming the first coupling unit 60A, the end of the connector interconnection member 64 and the connector body 66 are lightly joined to each other by spot welding, simple riveting, or temporary tightening, as in the temporary joining between the first end 52a and the first connector 62A, and, after the following “3-3) Full joining step”, full joining, that is, final joining, is performed by welding the connector interconnection member 64 and the connector body 66 over the entire circumference of the connector interconnection member 64. On the contrary, it is also permissible that the first coupling unit 60A is formed by full welding across the connector interconnection member 64 and the connector body 66 over the entire circumference of the connector interconnection member 64 and, thereafter, the next “3-3) Full joining step” is performed. In summary, what is required is only restricting the position of each of the first connectors 62A through the connector interconnection member 64 in advance of the next full joining step. Accordingly, the case where only low strength is required allows omission of full welding across the connector interconnection member 64 and the connector body 66.

3-3) Full Joining Step

In this full joining step, the first connector 62A and the first end 52a are welded across the outer peripheral surface 66a of the connector body 66 of the first connector 62A and the outer peripheral surface of the first end 52a, across the entire circumference of the main pipe 52 in the state where the plurality of first connectors 62A are temporarily joined to the first ends 52a of the main pipes 52, respectively, and the relative positions of the plurality of first connectors 62A are fixed by the forming the first coupling unit 60A, as described above. Thus, the first connector 62A and the first end 52a are fully joined to each other.

In the full joining, the connector interconnection members 64 in the first coupling unit 60A, fixing the relative positions of the first connectors 62A, effectively prevents the relative positions from being misaligned due to thermal strain involved by the welding across the outer peripheral surfaces 66a of the connector bodies 66 and the first ends 52a over the entire circumference. This ensures respective normal connections of the plurality of first connectors 62A to a plurality of counterpart connectors, that is, the second connectors 62B in another lattice structure adjacent to the second boom member 16B, namely, the third boom member 16C, regardless of the welding according to the full joining step.

In the thus formed second and third boom members 16B and 16C, the connector interconnection members 64 function as connection members for interconnecting the plurality of main pipes 52 through the first and second connectors 62A and 62B (so-called frame members that form a frame at the end of the lattice structure in the present embodiment); this enables the above-described effect to be obtained without involving significant increase in the number of components and in weight of the entire lattice structure.

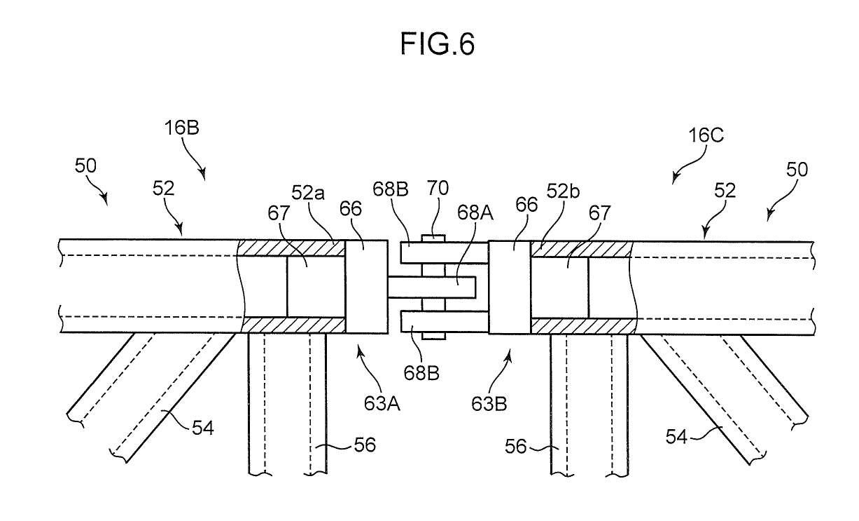

Furthermore, even when torsional load about the center axes of the boom members 16A to 16D as the lattice structures is exerted to the boom members 16A to 16D due to, for example, the slewing of the upper slewing body 12, the connector interconnection members 64 directly interconnecting the plurality of first connectors 62A (second connectors 62B) in the completed lattice structure (for example, the second boom member 16B) can effectively prevent the relative positions of the plurality of first connectors 62A and the relative positions of the plurality of second connectors 62B from being varied by the torsional loading to thereby allow respective normal connections between the first and second connectors 62A and 62B to be maintained for a long term. For example, a frame member 56 shown in FIG. 6 as a comparative example, not being the connector interconnection members 64 for interconnecting first connectors 63A or interconnecting second connectors 63B but interconnecting respective ends 52a of the main pipes 52 according to conventional techniques, cannot prevent the connectors from their relative displacements, the relative displacements having the potential of disabling the first connector 63A and the second connector 63B from their mutual connection. In contrast, the connector interconnection members 64 according to the above-described embodiment makes it possible to ensure mutual connection and disconnection of the first connector 62A and the second connector 62B for a long term.

The present invention is not limited to the above-described embodiment, encompassing, for example, the following modes.

A) Regarding Connectors and Connector Interconnection Members Included in Coupling Unit

The number of connectors included in the coupling unit according to the present invention only has to be two or more, not being required to be equal to the number of the main pipes. For example, it is also possible that only a part of the plurality of connectors to be joined to respective main pipes constituting the lattice structure are interconnected through a connector interconnection member, that is, only a part of the plurality of connectors forms the coupling unit. Thus fixing the relative position of only a part of the plurality of connectors also can effectively reduce the probability that the plurality of connectors and the counterpart connectors are disabled from being mutually connected.

For the similar reason, the coupling unit according to the present invention only has to include at least one connector interconnection member for connecting two or more connectors. Besides, the connector interconnection member is not limited to a member interconnecting connectors adjacent to each other. For example, in the case of disposition of a plurality of connectors at respective positions according to vertices of a polygon, it is also possible to dispose a connector interconnection member so as to interconnect the diagonally opposite connectors. In other words, the connector interconnection member may be a member functioning as a so-called diagonal member in a lattice structure.

B) Regarding Mode of Connection Between Connector and Connector Interconnection Member

The connector interconnection member according to the present invention only has to be at least a part thereof is joined to the connector. For example, it is permissible to join the end of the connector interconnection member 64 to the connector body 66 and the first end 52a (or the second end 52b) in the first connector 62A (or the second connector 62B) thereacross in the embodiment described above and to weld the first connector 62A and the first end 52a over the entire circumference of the end of the connector interconnection member 64. However, welding the end of the connector interconnection member 64 to the connected part (a part of the connector body 66) over the entire circumference as shown in the present embodiment enables a weld portion 75 and a weld portion 76 shown in FIG. 5 to be separate from each other, the weld portion lying across the outer peripheral surface of the end (first end 52a in FIG. 5) of the main pipe 52 and the outer peripheral surface of the connector (first connector 62A in FIG. 5) over the entire circumference, while the weld portion 76 lying across the connected part of this connector and the end of the connector interconnection member 64 over the entire circumference. This allows the weld portions 75 and 76 to secure their sufficient strengths.

C) Regarding Connection Unit Included in Lattice Structure

The “lattice structure” according to the present invention only has to include at least one coupling unit. For example, in the case of applying the present invention to the first boom member 16A whose proximal end constitutes the boom foot 17, out of the first to fourth boom members 16A to 16D shown in FIG. 1, it is also permissible to provide the coupling unit only to the distal end of the first boom member 16A. On the contrary, in the case of applying the present invention to the fourth boom member 16D to which the jib 18 or the like is connected at the distal end, it is also permissible to provide the coupling unit only to the proximal end of the fourth boom member 16D. Besides, in the case of applying the present invention to the intermediate boom member such as the second boom member 16B or the third boom member 16C, it is also permissible to provide the coupling unit according to the present invention only to one end of the member. In summary, regarding a lattice structure in which respective connectors are joined to opposite ends of the plurality of main pipes, it is also permissible to perform interconnection only of the connectors joined to one ends of the plurality of main pipes through the connector interconnection member.

D) Regarding Shape and Structure of Lattice Structure

The specific shape and structure of the lattice structure according to the present invention are not limited to those according to the above-mentioned embodiment. For example, although the plurality of main pipes 52 constituting the intermediate boom members 16B and 16C in the above-described embodiment are disposed so as to make their respective axes be parallel to each other, “the plurality of main pipes are spaced perpendicularly to their respective axial directions of the main pipes the plurality of main pipes” with respect to the present invention is intended to encompass a mode where the axes of at least a part of the plurality of main pipes are not parallel to each other as in the boom members 16A and 16D in the above embodiment, that is, a mode where the plurality of main pipes are disposed such that the axis of at least one main pipe is inclined to the longitudinal direction of the lattice structure, for example, a mode where the entire lattice structure has a pyramid shape or a truncated pyramid shape. Besides, “the plurality of main pipes are spaced perpendicularly to their respective axial directions of the main pipes the plurality of main pipes” is not intended to limit the main pipes to ones spaced over the longitudinally entire region but to require the main pipes only to be spaced on at least one end to which the plurality of connectors are joined. For example, the lattice structure according to the present invention encompasses also one having the pyramid shape wherein the main pipes are interconnected at the opposite ends to the ends to which the connectors are joined.

E) Regarding Application of Lattice Structure

The lattice structure according to the present invention is not limited to one forming a boom of a crane. The lattice structure according to the present invention is also applicable to other raisable and lowerable members of the crane shown in FIG. 1, for example, a structure forming the jib 18 or the struts 21 and 22. Although not graphically shown, in the case where the mast 20 is formed of a lattice structure, the present invention can be also applied to the mast 20. The present invention also can be applied to a lattice structure forming a long work member in a work machine other than the crane.

F) Regarding Structure of Connector

The connector included in the lattice structure according to the present invention is not limited to one having a detachable connection part as shown in FIG. 4, that is, a connector where the first projecting piece 68A constitutes a male-type detachable connection part to be detachably connected to the pair of second projecting pieces 68B of the second connector 62B which is the counterpart connector and a connector where the pair of second projecting pieces 68B constitute a female-type detachable connection part. In summary, the specific structure of the detachable connection part of the connector according to the present invention is not limited. For example, the present invention encompasses a mode where the connector has a pair of first projecting pieces 68A as a detachable connection part while the counterpart connector includes a pair of second projecting pieces 68B as the detachable connection part, and a mode where one of the connectors has a pair of projecting pieces while the other connector has three projecting pieces. Besides, encompassed is also a mode where each of the first and second projecting pieces 68A and 68B has a plurality of pin insertion holes 69 and the connecting pin 70 is inserted through the pin insertion holes 69.

As described above, provided is a technique making it possible to accurately define relative positions of a plurality of connectors regardless of welding across a plurality of main pipes and the plurality of connectors in a lattice structure constituting a work machine.

Provided is a coupling unit to form an end of a lattice structure and to be coupled to an end of another lattice structure adjacent to the lattice structure, the lattice structure including a plurality of main pipes and a plurality of connection members that connects the plurality of main pipes to one another in a state where the plurality of main pipes are spaced perpendicularly to their respective axial directions of the main pipes. The coupling unit includes: a plurality of connectors disposed at respective axial ends of the plurality of main pipes and joined to the axial ends; and at least one connector interconnection member that interconnects the plurality of connectors. Each of the plurality of connectors includes: a fitted part capable of being fitted to an end of the main pipe corresponding to the connector; a detachable connection part that is detachably connectable to a counterpart connector provided to an end of the other lattice structure; an outer peripheral surface that is weldable to an outer peripheral surface of the end of the main pipe over an entire circumference of the main pipe in a state where the fitted part is fitted to the end of the main pipe; and a connected part to which an end of the connector interconnection member is to be connected.

In the coupling unit described above, the at least one connector interconnection member interconnects the plurality of connectors to thereby fix a relative position of the plurality of connectors. This makes it possible to effectively prevent a change in the relative position of the plurality of connectors caused by thermal strain due to the welding which is applied across the outer peripheral surfaces of the plurality of connectors and the outer peripheral surfaces of the plurality of main pipes over the entire circumference in a state where the fitted parts of the connectors are fitted to the plurality of main pipes, respectively, thus enabling the plurality of connectors to be more reliably and detachably connected to a plurality of corresponding counterpart connectors. In addition, the at least one connector interconnection member can function as a interconnection member for interconnecting the plurality of main pipes to which the plurality of connectors is to be welded, respectively; hence, the plurality of connectors can be connected to the plurality of counterpart connectors without entailing a significant increase in the number of components and weight of the entire lattice structure.

As a specific mode, it is preferable that the plurality of connectors include three or more connectors disposed at respective positions corresponding to vertices of a polygon having three or more vertices as viewed in the axial direction of the main pipes, and the at least one connector interconnection member includes three or more connector interconnection members disposed to interconnect adjacent connectors of the plurality of connectors. The disposition of the connector interconnection members described above enables the three or more connectors to be efficiently and effectively interconnected.

It is preferable that the connected part of each of the plurality of connectors is located between the detachable connection part and the fitted part, having a size allowing the end of the connector interconnection member to be joined to the connected part over an entire circumference of the end of the connector interconnection member. This enables the connector and the connector interconnection member to be stably connected to each other, thereby allowing the relative position of the plurality of connectors to be further stabilized.

Besides, according to the present invention, provided is a lattice structure constituting a work machine, the lattice structure being detachably coupled to another lattice structure adjacent to the lattice structure. The lattice structure includes: a plurality of main pipes; a plurality of connection members that interconnects the plurality of main pipes which are spaced in a direction perpendicular to an axial direction of the main pipes; and the coupling unit, wherein the fitted parts of the plurality of connectors in the coupling unit are fitted to axial ends of the plurality of main pipes, respectively, and outer peripheral surfaces of the connectors are welded to outer peripheral surfaces of the ends of the main pipes, respectively, over an entire circumference of the main pipes.

In the lattice structure, the at least one connector interconnection member, directly interconnecting the plurality of connectors which are to be joined to axial ends of the plurality of main pipes, respectively, thereby effectively preventing the relative positions of connectors to be varied because of torsional loading, which is applied, for example, to the lattice structure about a center axis of the lattice structure. This ensures connection and disconnection between the connectors in the lattice structure and counterpart connectors in another lattice structure adjacent to the lattice structure, in spite of repeated use of the lattice structure.

In addition, since the at least one connector interconnection member can function as a connection member for connecting the plurality of main pipes, to which the plurality of connectors are to be welded, respectively, not involving a significant increase in the number of components and weight of the entire lattice structure.

As a specific mode, it is preferable that the plurality of main pipes include three or more main pipes disposed at respective positions corresponding to vertices of a polygon having three or more vertices as viewed in the axial direction of the main pipes, the plurality of connectors include three or more connectors to be joined to axial ends of the three or more main pipes, respectively, and the at least one connector interconnection member includes three or more connector interconnection members disposed so as to interconnect adjacent connectors of the plurality of connectors.

The connector interconnection member only has to be joined to the connector in at least a part thereof. For example, the connector interconnection member may be joined across the connector and the end of the main pipe to which this connector is to be welded. However, it is more preferable that the end of the connector interconnection member is welded to the connected part of each of the plurality of connectors over the entire circumference of the end of the connector interconnection member. This enables a welding across the outer peripheral surface of the end of the main pipe and the outer peripheral surface of the connector over the entire circumference and a welding across the connected part of the connector and the end of the connector interconnection member over the entire circumference to be independent from each other, thereby allowing the weldings to secure their sufficient strengths.

Furthermore, according to the present invention, also provided is a method for manufacturing a lattice structure constituting a work machine, the lattice structure configured to be detachably connected to another lattice structure adjacent to the lattice structure. This method includes: a step of preparing a structure body including a plurality of main pipes and a plurality of connection members interconnecting the plurality of main pipes in a state where the plurality of main pipes are spaced perpendicularly to an axial direction of the main pipes; a step of preparing a plurality of connectors corresponding to the plurality of main pipes, respectively, each of the plurality of connectors including a fitted part capable of being fitted to an end of the corresponding main pipe and a detachable connection part which is detachably connected to a counterpart connector provided to an end of the other lattice structure; a step of temporarily joining the plurality of connectors to ends of the plurality of main pipes, respectively, the temporary joining including fitting the fitted part of each of the connectors with the corresponding end of the main pipe so as to allow the connector to be relatively displaced to the end of the main pipe; a step of interconnecting the plurality of connectors through at least one connector interconnection member, in a state where the ends of the main pipes and the connectors are temporarily joined to each other, thereby forming a coupling unit including the plurality of connectors and the at least one connector interconnection member to fix relative positions of the plurality of connectors; and a step of performing full joining of welding outer peripheral surfaces of the plurality of connectors to outer peripheral surfaces of the ends of the main pipes over an entire circumference of the main pipes in a state where the plurality of connectors are fitted to the ends of the main pipes, respectively, and the relative positions of the plurality of connectors are fixed through forming the coupling unit.

This method includes the full joining, that is, welding across the outer peripheral surfaces of the plurality of connectors and the corresponding ends of the main pipes over the entire circumference, the full joining being performed in a state where the coupling unit is formed in which the relative positions of the plurality of connectors are fixed due to the interconnection of the plurality of connectors through the at least one connector interconnection member, thereby effectively preventing the relative positions of the plurality of connectors from being varied by thermal strain due to the welding. This makes it possible to ensure respective normal connections of the plurality of connectors to the plurality of counterpart connectors in another lattice structure regardless of the welding in the full joining.

The temporary joining between the ends of the plurality of main pipes and the plurality of connectors only has to include at least fitting of the ends of the main pipes and the fitted parts of the connectors with each other. However, it is more preferable that the temporary joining includes joining which prevents each of the connectors from being disengaged from the corresponding main pipe while allowing relative displacement of the connector to the end of the main pipe.

In the above-described method, the joining between the plurality of connectors and the at least one connector interconnection member for forming the coupling unit is only required to allow the connector interconnection member to fix the relative positions of the plurality of connectors, thus not being required to provide perfect welding. For example, it is also possible that the coupling unit is formed by joining between the ends of the connector interconnection member and the connectors in a degree lower than a degree of welding over the entire circumference of the connector interconnection member, namely, final joining, and the ends of the connector interconnection member and the connectors are welded over the entire circumference of the connector interconnection member after the full joining is completed. On the contrary, it is also possible that the coupling unit is formed by welding across the ends of the connector interconnection member and the connectors over the entire circumference of the connector interconnection member, and the full joining between the plurality of connectors and the ends of the plurality of main pipes is thereafter performed. Besides, the welding across the ends of the connector interconnection member and the connectors over the entire circumference of the connector interconnection member is not absolutely required.

This application is based on Japanese Patent application No. 2017-157851 filed in Japan Patent Office on Aug. 18, 2017, the contents of which are hereby incorporated by reference.

Although the present invention has been fully described by way of example with reference to the accompanying drawings, it is to be understood that various changes and modifications will be apparent to those skilled in the art. Therefore, unless otherwise such changes and modifications depart from the scope of the present invention hereinafter defined, they should be construed as being included therein.

1. A coupling unit to form an end of a lattice structure and to be connected to an end of another lattice structure adjacent to the lattice structure, the lattice structure including a plurality of main pipes and a plurality of connection members that connects the plurality of main pipes to one another in a state where the plurality of main pipes are spaced perpendicularly to their respective axial directions of the main pipes, the coupling unit comprising:
a plurality of connectors disposed at respective axial ends of the plurality of main pipes and joined to the axial end; and
at least one connector interconnection member that interconnects the plurality of connectors,
wherein each of the plurality of connectors includes: a fitted part capable of being fitted to an end of the main pipe corresponding to the connector; a detachable connection part that is detachably connectable to a counterpart connector provided to an end of the other lattice structure; an outer peripheral surface that is weldable to an outer peripheral surface of the end of the main pipe over an entire circumference of the main pipe in a state where the fitted part is fitted to the end of the main pipe; and a connected part to which an end of the connector interconnection member is to be connected.

2. The coupling unit for a lattice structure according to claim 1, wherein the plurality of connectors include three or more connectors disposed at respective positions corresponding to vertices of a polygon having three or more vertices as viewed in the axial direction of the main pipes, and the at least one connector interconnection member includes three or more connector interconnection members disposed so as to interconnect adjacent connectors of the plurality of connectors.

3. The coupling unit for a lattice structure according to claim 1, wherein the connected part is located between the detachable connection part and the fitted part, having a size allowing the end of the connector interconnection member to be joined to the connected part over an entire circumference of the connector interconnection member.

4. A lattice structure constituting a work machine and configured to be detachably coupled to another lattice structure adjacent to the lattice structure, the lattice structure comprising:
a plurality of main pipes;
a plurality of connection members that connects the plurality of main pipes to one another in a state where the plurality of main pipes are spaced perpendicularly to an axial direction of the main pipes; and
the coupling unit according to claim 1,
wherein, respective outer peripheral surfaces of the connectors are welded to respective outer peripheral surfaces of the axial ends of the main pipes over an entire circumference of the main pipes, respectively, in a state where the fitted parts of the plurality of connectors in the coupling unit are fitted to respective axial ends of the plurality of main pipes, respectively.

5. The lattice structure according to claim 4, wherein: the plurality of main pipes includes three or more main pipes disposed at respective positions corresponding to vertices of a polygon having three or more vertices as viewed in the axial direction of the main pipes; the plurality of connectors include three or more connectors to be joined to respective axial ends of the three or more main pipes, respectively; and the at least one connector interconnection member includes three or more connector interconnection members disposed so as to interconnect adjacent connectors of the plurality of connectors.

6. The lattice structure according to claim 4, wherein the connected part of each of the plurality of connectors is located between the detachable connection part and the fitted part, and the end of the connector interconnection member is welded to the connected part over an entire circumference of the connector interconnection member.

7. A method for manufacturing a lattice structure constituting a work machine, the lattice structure configured to be detachably coupled to another lattice structure adjacent to the lattice structure, the method comprising:
a step of preparing a structure body including a plurality of main pipes and a plurality of connection members interconnecting the plurality of main pipes in a state where the plurality of main pipes are spaced perpendicularly to an axial direction of the main pipes;
a step of preparing a plurality of connectors corresponding to the plurality of main pipes, respectively, each of the plurality of connectors including a fitted part capable of being fitted to an end of the corresponding main pipe and a detachable connection part which is detachably connected to a counterpart connector provided to an end of the other lattice structure;
a step of temporarily joining the plurality of connectors to ends of the plurality of main pipes, respectively, the temporary joining including fitting the fitted part of each of the connectors with the corresponding end of the main pipe so as to allow the connector to be relatively displaced to the end of the main pipe;
a step of interconnecting the plurality of connectors through at least one connector interconnection member, in a state where the ends of the main pipes and the connectors are temporarily joined to each other, thereby forming a coupling unit including the plurality of connectors and the at least one connector interconnection member to fix relative positions of the plurality of connectors; and
a step of performing full joining of welding outer peripheral surfaces of the plurality of connectors to outer peripheral surfaces of the ends of the main pipes over an entire circumference of the main pipes in a state where the plurality of connectors are fitted to the ends of the main pipes, respectively, and the relative positions of the plurality of connectors are fixed through forming the coupling unit.

8. The method for manufacturing a lattice structure according to claim 7, wherein the temporary joining further includes joining that prevents each of the connectors from being disengaged from the corresponding main pipe while allowing the connector to be displaced relatively to the end of the main pipe.

9. The method for manufacturing a lattice structure according to claim 7, wherein joining between the plurality of connectors and the at least one connector interconnection member for forming the coupling unit is joining in a degree lower than a degree of welding across the ends of the connector interconnection member and the connectors over the entire circumference of the connector interconnection member, and welding across the ends of the connector interconnection member and the connectors over the entire circumference of the connector interconnection member is performed after the full joining between the plurality of connectors and the ends of the plurality of main pipes is completed,.

10. The method for manufacturing a lattice structure according to claim 7, wherein the coupling unit is formed by welding across the ends of the connector interconnection member and the connectors over the entire circumference of the connector interconnection member, and the full joining between the plurality of connectors and the ends of the plurality of main pipes is thereafter performed.
